(19) United States
(12) Patent Application Publication
(10) Pub. No.: US 2005/0248319 A1
(43) Pub. Date: Nov. 10, 2005

(54) Battery failure discharge apparatus

(75) Inventor: Jay L. Taylor, Georgetown, TX (US)

Correspondence Address: HAYNES AND BOONE, LLP, 901 MAIN STREET, SUITE 3100, DALLAS, TX, 75202, US

(73) Assignee: Dell Products L.P., Round Rock, TX (US)

(21) Appl. No.: 10/839,591

(22) Filed: May 5, 2004

(51) Int. Cl. H02J 7/00

(52) U.S. Cl. 320/136

(57) ABSTRACT

A battery failure discharge apparatus includes a battery discharge device operable to drain power from a battery. A monitoring and control device is coupled to the battery discharge device and operable to detect that a battery is in an over-voltage condition. In response to detecting a battery in an over-voltage condition, the monitoring and control device is operable to discharge a battery through the battery discharge device until the battery charge is below a predetermined value.

### BACKGROUND

The present disclosure relates generally to information handling systems, and more particularly to a battery failure discharge apparatus.

As the value and use of information continues to increase, individuals and businesses seek additional ways to process and store information. One option available to users is information handling systems. An information handling system generally processes, compiles, stores, and/or communicates information or data for business, personal, or other purposes thereby allowing users to take advantage of the value of the information. Because technology and information handling needs and requirements vary between different users or applications, information handling systems may also vary regarding what information is handled, how the information is handled, how much information is processed, stored, or communicated, and how quickly and efficiently the information may be processed, stored, or communicated. The variations in information handling systems allow for information handling systems to be general or configured for a specific user or specific use such as financial transaction processing, airline reservations, enterprise data storage, or global communications. In addition, information handling systems may include a variety of hardware and software components that may be configured to process, store, and communicate information and may include one or more computer systems, data storage systems, and networking systems.

Batteries, such as lithium ion batteries, may be employed in information handling systems for a number of reasons, such as increasing their portability. Issues may arise when these batteries begin to fail.

Batteries may fail for a number of reasons, including when the battery cell experiences an over-voltage condition. An over-voltage condition is usually said to exist when the battery achieves a voltage magnitude that is substantially higher than its nominal value. When a battery enters this failure mode, that battery will no longer charge but may maintain a high charge level until internal resistance can reduce the voltage in the battery. Voltage reduction to a desired level by internal resistance may take a period of months, during which the battery will be unstable. This instability may result in the electrolyte liquid in the battery emitting a gas, which can build up pressure in the battery. In addition, subjecting the battery to high temperatures may cause, or increase, the gas emission. This gas emission can ultimately cause battery failure.

Accordingly, it would be desirable to provide an improved battery failure discharge apparatus in an information handling system absent the disadvantages found in the prior methods discussed above.

### SUMMARY

According to one embodiment, a battery failure discharge apparatus includes a battery discharge device operable to drain power from a battery. A monitoring and control means is coupled to the battery discharge device and operable to detect that a battery is in an over-voltage condition. In response to detecting a battery in an over-voltage condition, the monitoring and control means is operable to discharge a battery through the battery discharge device until the battery charge is below a predetermined value.

### BRIEF DESCRIPTION OF THE DRAWINGS

FIG. 1 is a diagrammatic view illustrating an embodiment of an information handling system.

FIG. 2a is a perspective view illustrating an embodiment of a housing for an information handling system.

FIG. 2b is a perspective view illustrating an embodiment of a housing for an information handling system.

FIG. 3 is a perspective view illustrating an embodiment of a battery.

FIG. 4 is a perspective view illustrating an embodiment of a battery and a housing for an information handling system being connected.

FIG. 5 is a schematic view illustrating an embodiment of a battery coupled to a monitor/controller device, with the monitor/controller device coupled to a battery discharge device.

FIG. 6 is a flow chart illustrating an embodiment of the monitor/controller device in operation.

### DETAILED DESCRIPTION

For purposes of this disclosure, an information handling system may include any instrumentality or aggregate of instrumentalities operable to compute, classify, process, transmit, receive, retrieve, originate, switch, store, display, manifest, detect, record, reproduce, handle, or utilize any form of information, intelligence, or data for business, scientific, control, or other purposes. For example, an information handling system may be a personal computer, a network storage device, or any other suitable device and may vary in size, shape, performance, functionality, and price. The information handling system may include random access memory (RAM), one or more processing resources such as a central processing unit (CPU) or hardware or software control logic, ROM, and/or other types of nonvolatile memory. Additional components of the information handling system may include one or more disk drives, one or more network ports for communicating with external devices as well as various input and output (I/O) devices, such as a keyboard, a mouse, and a video display. The information handling system may also include one or more buses operable to transmit communications between the various hardware components.

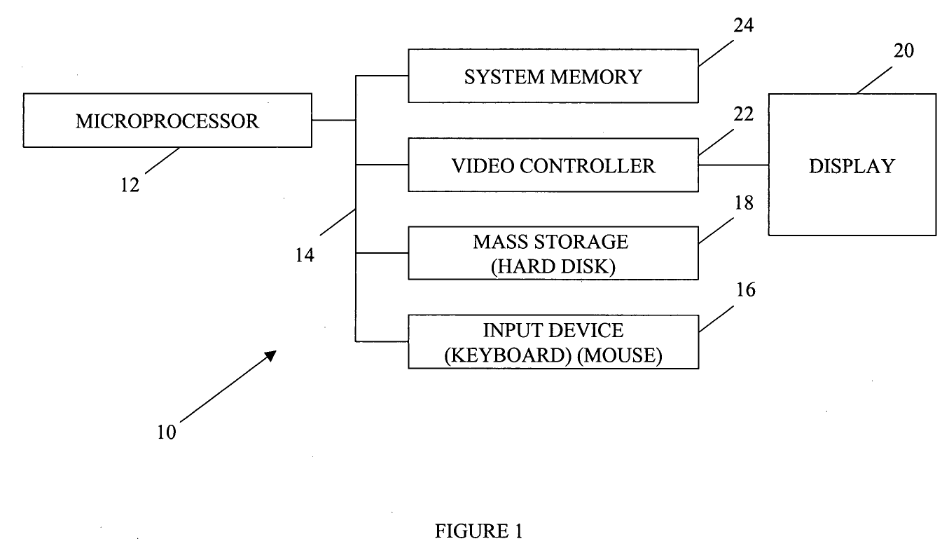

In one embodiment, information handling system 10, FIG. 1, includes a microprocessor 12, which is connected to a bus 14. Bus 14 serves as a connection between microprocessor 12 and other components of computer system 10. An input device 16 is coupled to microprocessor 12 to provide input to microprocessor 12. Examples of input devices include keyboards, touchscreens, and pointing devices such as mouses, trackballs and trackpads. Programs and data are stored on a mass storage device 18, which is coupled to microprocessor 12. Mass storage devices include such devices as hard disks, optical disks, magneto-optical drives, floppy drives and the like. Computer system 10 further includes a display 20, which is coupled to microprocessor 12 by a video controller 22. A system memory 24 is coupled to microprocessor 12 to provide the microprocessor with fast storage to facilitate execution of computer programs by microprocessor 12. A housing 26 contains the components of information handling system 10. Housing 26 may be a single housing or a plurality of housings. It should be understood that other busses and intermediate circuits can be deployed between the components described above and microprocessor 12 to facilitate interconnection between the components and the microprocessor.

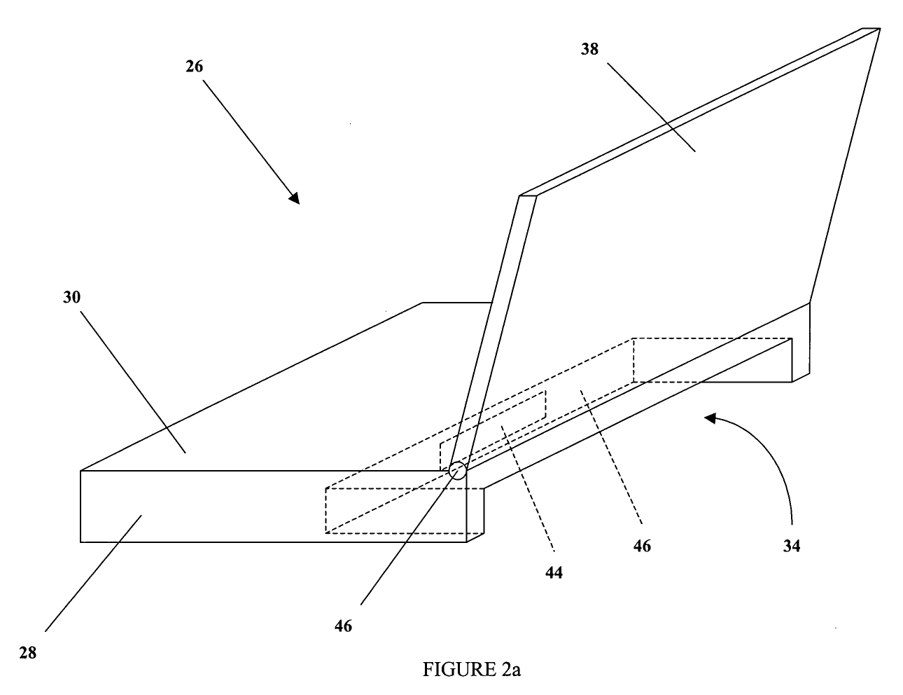

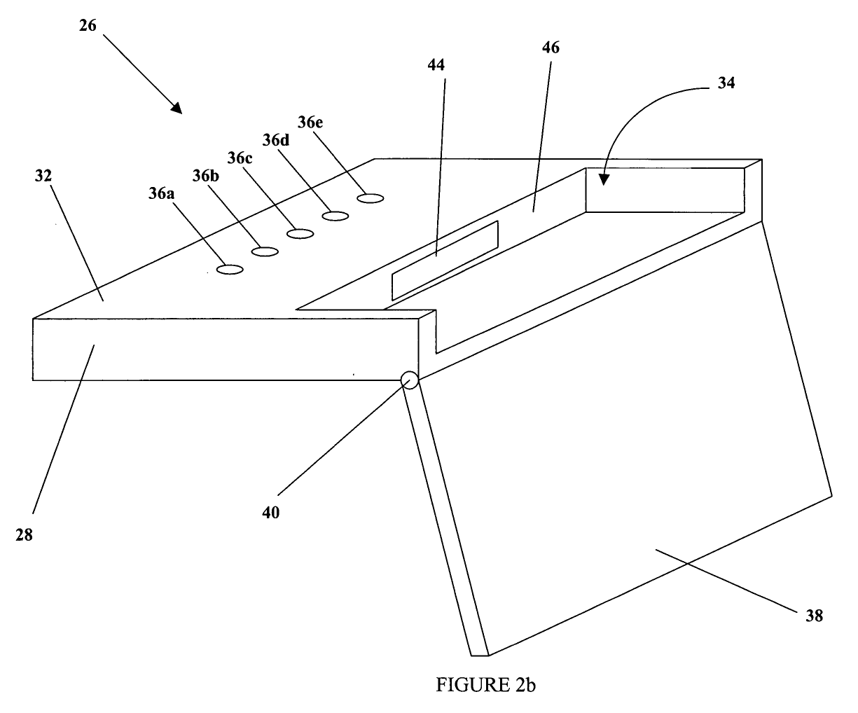

A housing 26, FIGS. 2a and 2b, may be a housing for a portable computer. Housing 26 includes a base section 28. Base section 28 includes an upper surface 30 and a lower surface 32. A cavity 34 is located in the base section 28 adjacent the lower surface 32. A plurality of light emitting diodes (LED's) 36a, 36b, 36c, 36d, and 36e are situated on the lower surface 32. A screen section 38 is pivotally coupled to the base section 28 by a hinge 40. A battery connection 44 is located on a surface 46 of the cavity 34.

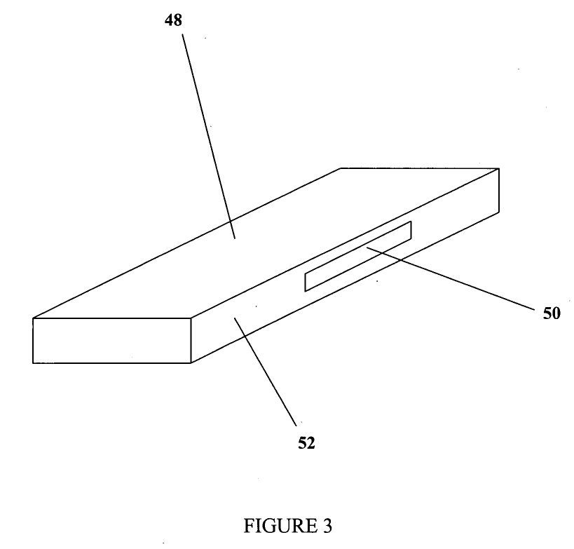

A battery 48, FIG. 3, includes a connector 50 on a surface 52 of the battery 48.

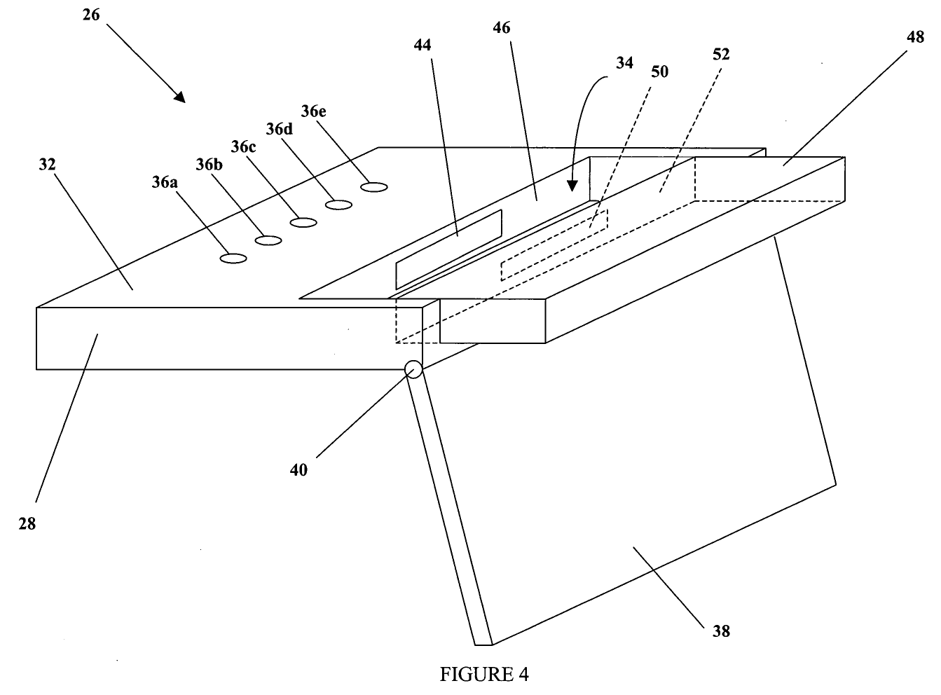

In operation, FIG. 4, battery 48 may be connected to system 10 by placing battery 48 into cavity 34. Surface 52 on battery 48 is then brought towards surface 46 in cavity 34, causing battery connection 44 to engage connector 46 on battery 36 in order to provide power to the system 10.

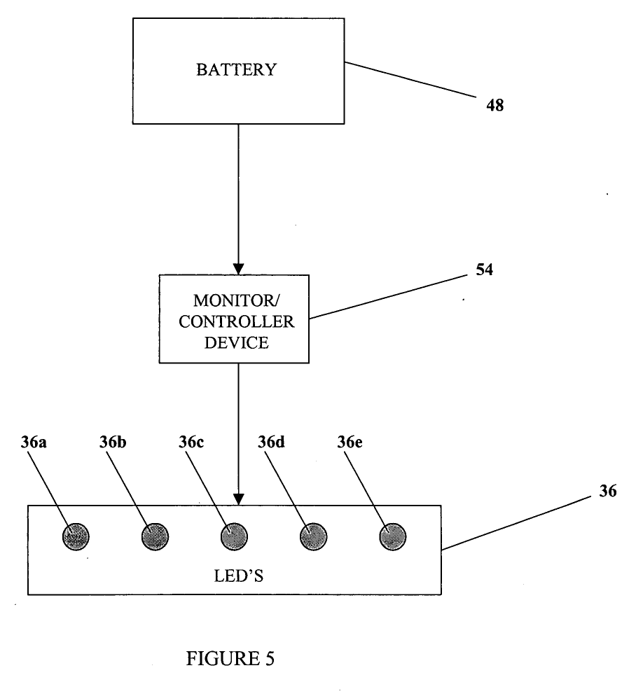

With battery 48 situated in the housing 26 and connector 46 engaging battery connector 44, battery 48 provides power to the system 10. Battery 48 carries a charge, which can be measured as a percentage of a value called the relative state of charge (RSOC). The RSOC is a close approximation of the remaining capacity of the battery 48 and depends on a number of factors including the age, the number of charge/discharge cycles, the voltage level, the current consumption, and the temperature of battery 48. Coupled to battery 48 is a monitor/controller device 54, FIG. 5. Coupled to monitor controller device 54 is a battery discharge device 36 including the plurality of LED's 36a, 36b, 36c, 36d, and 36e. Monitor/controller device 54 monitors battery 48 and controls LED's 36a-e in battery discharge device 36. Monitor/controller device 54 may be a single device or a plurality of devices.

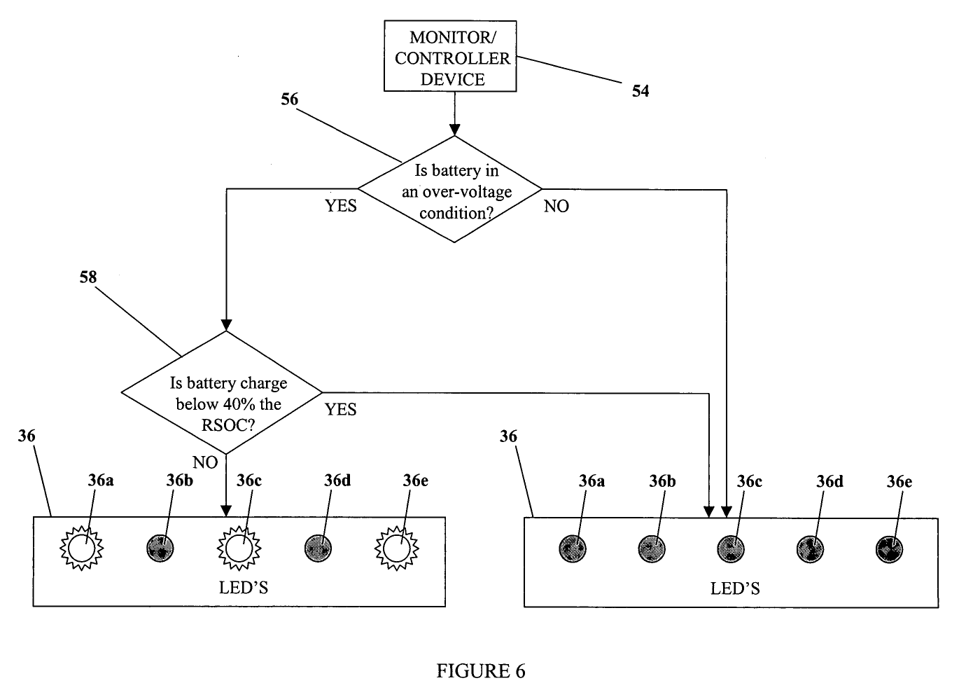

In operation, FIG. 6, monitor/controller device 54 is monitoring battery 48 (not shown). Monitor/controller device 54 conducts a test at decision block 56 to determine whether battery 48 is in an over-voltage condition. If the battery is not in an over-voltage condition, LED's 36a-e are not supplied power from battery 28. However, if the battery is in an over-voltage condition then monitor/controller device 54 conducts another test at decision block 58 to determine whether battery 48 has a charge lower than 40% the RSOC. In other embodiments, this charge threshold may be higher or lower than 40% the RSOC, depending on considerations such as battery environment. If battery 48 has a charge lower than 40% the RSOC, LED's 36a-e are not supplied power from battery 48. However, if battery 48 has a charge higher than 40% the RSOC, LED's 36a, 36c, and 36e are supplied power from battery 48. Supplying LED's 36a, 36c, and 36e power from battery 48 will cause them to emit light and begin to drain battery 48 of its charge. This will continue until battery 48 has a charge lower than 40% the RSOC, resulting in the stabilization of battery 48 from its over-voltage condition. Furthermore, the lighting of particular LED's, such as LED's 36a, 36c, and 36e and not LED's 36b and 36d, may be used to indicate to a service technician that the battery is experiencing an over-voltage condition. In other embodiments, indicators may include supplying power to different combinations of the LED's or flashing the LED's in unison or possibly in a timed pattern.

Although illustrative embodiments have been shown and described, a wide range of modification, change and substitution is contemplated in the foregoing disclosure and in some instances, some features of the embodiments may be employed without a corresponding use of other features. Accordingly, it is appropriate that the appended claims be construed broadly and in a manner consistent with the scope of the embodiments disclosed herein.

1. A battery failure discharge apparatus comprising:
a battery discharge device operable to drain power from a battery; and
a monitoring and control means coupled to the battery discharge device operable to detect that a battery is in an over-voltage condition and, in response to detecting an over-voltage condition, operable to discharge a battery through the battery discharge device until battery charge level is below a predetermined value.

2. The apparatus of claim 1 wherein the battery discharge device includes at least one LED.

3. The apparatus of claim 1 wherein the monitoring and control means is a microcontroller.

4. The apparatus of claim 1 wherein the predetermined value is substantially 40% of the batteries relative state of charge.

5. The apparatus of claim 1 wherein the battery discharge device includes a plurality of LED's, whereby the LED's are operable to indicate information about the battery.

6. The apparatus of claim 5 wherein the plurality of LED's operate in a particular manner in response to the monitoring and controlling means detecting the battery in an over-voltage condition.

7. A battery failure discharge apparatus comprising:
a charged battery;
a charge dissipating device coupled to the battery operable to discharge the battery; and
a controller coupled to the battery and the charge dissipating device operable to detect that the battery is in an over-voltage condition and, in response to detecting an over-voltage condition, operable to activate the charge dissipating device to discharge the battery until the battery charge is below a predetermined level.

8. The apparatus of claim 7 wherein the charge dissipating device includes at least one LED.

9. The apparatus of claim 7 wherein the controller is a microcontroller.

10. The apparatus of claim 7 wherein the predetermined value is substantially 40% of the batteries relative state of charge.

11. The apparatus of claim 7 wherein the charge dissipating device includes a plurality of LED's, whereby the LED's are operable to indicate information about the battery.

12. The apparatus of claim 11 wherein the plurality of LED's operate in a particular manner in response to the controller detecting the battery in an over-voltage condition.

13. An information handling system comprising:
a housing;
a microprocessor mounted in the housing;
a storage coupled to the microprocessor;
a charged battery situated in the housing and coupled to the system operable to provide power to the system;
a battery discharge device coupled to the battery; and
a monitoring and control means coupled to the battery operable to detect that the battery is in an over-voltage condition and, in response to detecting an over-voltage condition, operable to discharge the battery through the battery discharge device until the battery charge is below a predetermined value.

14. The system of claim 13 wherein the battery discharge device includes at least one LED.

15. The system of claim 13 wherein the monitoring and control means is a microcontroller.

16. The system of claim 13 wherein the predetermined value is substantially 40% of the batteries relative state of charge.

17. The system of claim 13 wherein the battery discharge device includes a plurality of LED's, whereby the LED's are operable to indicate information about the battery.

18. The system of claim 17 wherein the plurality of LED's operate in a particular manner in response to the monitoring and controlling means detecting the battery in an over-voltage condition.

19. A method for discharging a battery in response to battery failure comprising:
providing a charged battery;
coupling a battery discharge device to the battery;
monitoring the battery to detect an over-voltage condition; and
discharging the battery through the battery discharge device until the battery charge is below a predetermined level in response to detecting the over voltage condition.

20. The method of claim 19 further comprising:
providing a plurality of LED's as a component of the battery discharge device; and
indicating information about the battery using the plurality of LED's.
